(19) United States
(12) Patent Application Publication
(10) Pub. No.: US 2015/0368084 A1
(43) Pub. Date: Dec. 24, 2015

(54) PLASTIC BEER KEG

(71) Applicant: Rehrig Pacific Company, Los Angeles, CA (US)

(72) Inventor: William P. Apps, Alpharetta, GA (US)

(21) Appl. No.: 14/747,618

(22) Filed: Jun. 23, 2015

Related U.S. Application Data
(60) Provisional application No. 62/015,733, filed on Jun. 23, 2014.

(51) Int. Cl. B67D 1/08

(52) U.S. Cl. CPC B67D 1/0832; B67D 1/0801; B67D 1/0841; B67D 2001/0822

(57) ABSTRACT

A beer keg assembly includes a liner or bottle having a body portion and a neck portion. A valve assembly is in the neck portion of the liner. The valve assembly includes an inner retainer portion having an inner annular surface formed on a portion of reduced diameter. A cap is secured to the inner retainer portion. At least one spring imparting force between the cap and the inner annular surface. The at least one spring may include an inner spring biasing a piston and a port against one another. The at least one spring may further include an outer spring, wherein the inner spring and the outer spring are both captured between the inner annular surface and the cap. A pressure relief valve may be disposed in a fluid path leading through a wall of the inner retainer portion.

### BACKGROUND

A known plastic beer keg includes an outer container with a lid having an opening therethrough. A liner or bottle includes a body portion and a neck portion. The neck portion is adjacent the opening through the lid. A valve assembly is received in the neck portion of the liner. The valve assembly is secured to external threads on the neck portion of the liner.

### SUMMARY

A beer keg assembly includes a liner or bottle having a body portion and a neck portion. A valve assembly is in the neck portion of the liner. The valve assembly includes an inner retainer portion having an inner annular surface formed on a portion of reduced diameter. A cap is secured to the inner retainer portion. At least one spring imparting force between the cap and the inner annular surface. The at least one spring may include an inner spring biasing a piston and a port against one another. The at least one spring may further include an outer spring, wherein the inner spring and the outer spring are both captured between the inner annular surface and the cap. A pressure relief valve may be disposed in a fluid path leading through a wall of the inner retainer portion.

### BRIEF DESCRIPTION OF THE DRAWINGS

FIG. 1 is a section view through a beer keg assembly according to one embodiment.

FIG. 2 is an exploded perspective view of the valve assembly of FIG. 1.

FIG. 3 is an exploded perspective view of the inner and outer retainer of FIG. 2.

FIG. 4 is an exploded perspective view of the inner and outer retainers and cap of FIG. 2.

FIG. 5 is a section view through an assembled valve assembly of FIG. 1.

FIG. 6 is a perspective view, partially broken away, of the assembled inner and outer retainers and cap.

### DETAILED DESCRIPTION OF THE PREFERRED EMBODIMENTS

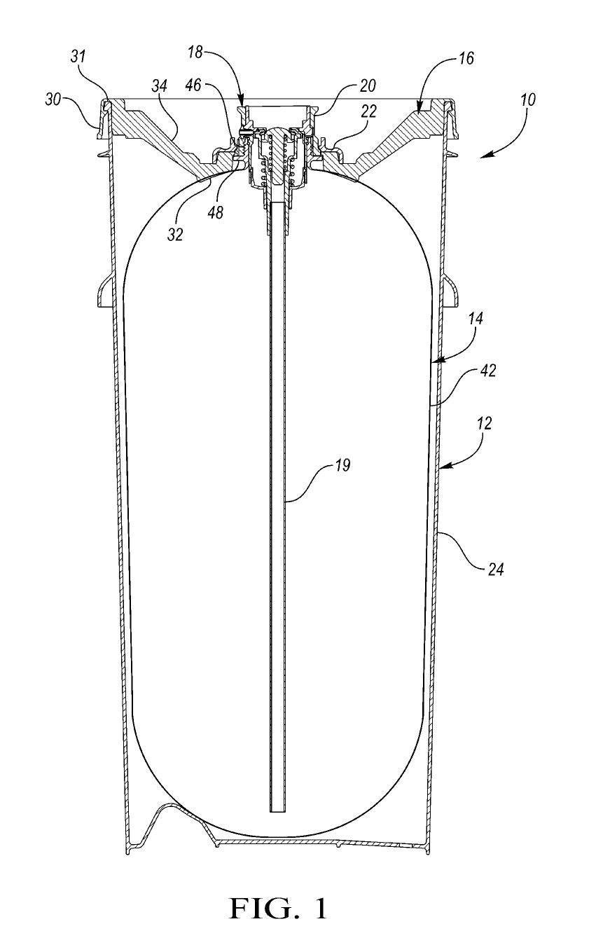

FIG. 1 shows a plastic beer keg 10 including an outer container 12 surrounding an inner liner 14, such as a PET bottle. A lid 16 is secured over an open end of the outer container 12 to retain the liner 14 within the interior of the outer container 12. A valve assembly 18 is retained in the mouth of the liner 14 by its outer retainer 20, which is part of the valve assembly 18 and which protrudes through an opening in the lid 16. The valve assembly 18 is shown in more detail in the subsequent figures.

A fastener, in this case a locking ring 22, is secured to the outer retainer 20 to secure the outer retainer 20 to the lid 16. In this example, the locking ring 22 is threaded to the outer retainer 20 to prevent the outer retainer 20 from moving downwardly through the opening in the lid 16.

The outer container 12 includes a tapered cylindrical outer wall 24 having an upper end to which the lid 16 is snap-fit or threaded. The lid 16 includes a lip 30 extending downward from a generally horizontal, annular rim portion 31 extending about the periphery of the lid 16 and over the upper edge of the outer wall 24 of the outer container 12. The lid 16 further includes a lower annular wall 32 spaced below the upper edge of the outer container 12 and connected by a frustoconical wall 34 to the outer periphery of the lid 16.

The liner 14 is a PET bottle or other suitable material having a body portion 42 and a neck 46, which as shown, may be threaded. A neck ring 48 (preferably, but not critically hexagonal or other non-circular shape) is integrally molded around the neck 46.

The outer retainer 20 of the valve assembly 18 is securable to the neck 46 of the liner 14 (such as by threading) in order to retain the valve assembly 18 within the neck 46. A semi-flexible tube 19 extends downward from the valve assembly 18 into the liner 14. The outer container 12, the lid 16, and the outer retainer 20 may each be separately molded of HDPE, polypropylene or other suitable materials.

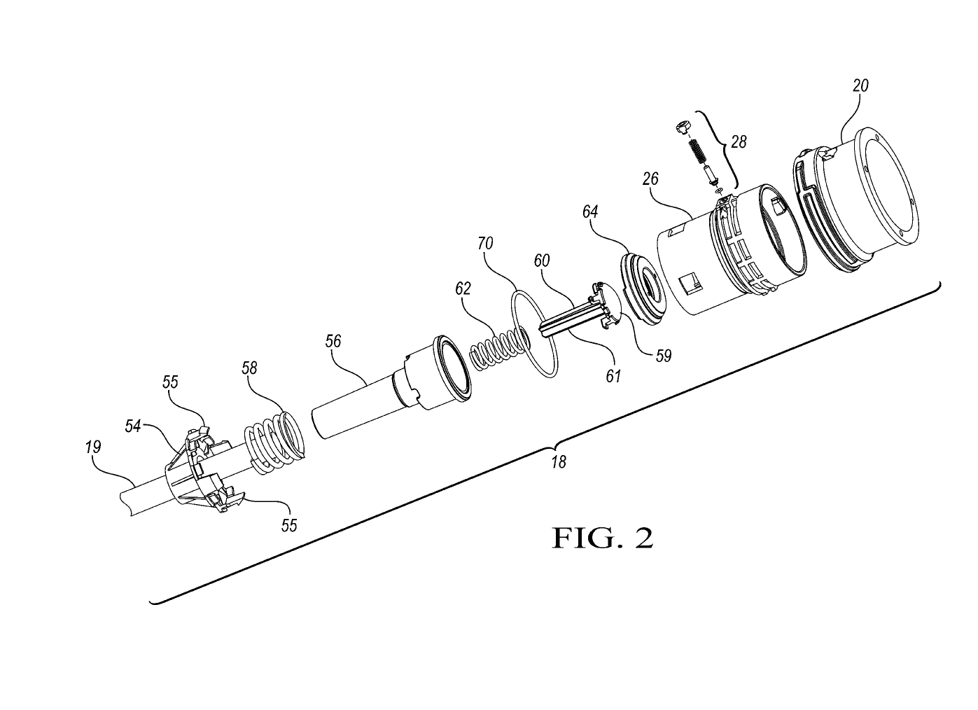

An exploded view of the valve assembly 18 is shown in FIG. 2. A retainer cap 54 has a plurality of snap-fit fingers 55. A valve body 56 received in the retainer cap 54 is connected to the tube 19 and biased away from the retainer cap 54 by an outer spring 58. A port 60 is received in the valve body 56 and biased away from the valve body 56 by an inner spring 62 toward a piston 64. The piston 64 is generally annular having an aperture therethrough. The port 60 includes a head portion 59 having a convex upper surface and an elongated stem portion 61 below the head portion 59. The head portion 59 seals against the piston 64, selectively closing the aperture through the piston 64. The piston 64 is received in an inner retainer 26, having an annular wall within which the rest of the components are at least partially received. The outer retainer 20 may include an annular wall having external threads (for connection to the locking ring 22, FIG. 1). A pressure relief valve assembly 28 is insertable radially into the annular wall of the inner retainer 26. An o-ring 70 may be provided on the inner retainer 26.

The inner retainer 26 and retainer cap 54 may be formed from POM which has good creep resistance and stiffness (to contain the outer spring 58) and which is rated highly for contact with food (in this case, beer). The outer retainer 20 may be formed of a higher strength, more durable material, such as glass-filled nylon, because the outer retainer 20 does not contact the beer. The outer retainer 20 is important to the strength and durability of the keg 10 because it connects the valve assembly 18 to the neck of the liner 14 and connects to the locking ring 22 which clamps the lid 16 between the liner 14 and locking ring 22.

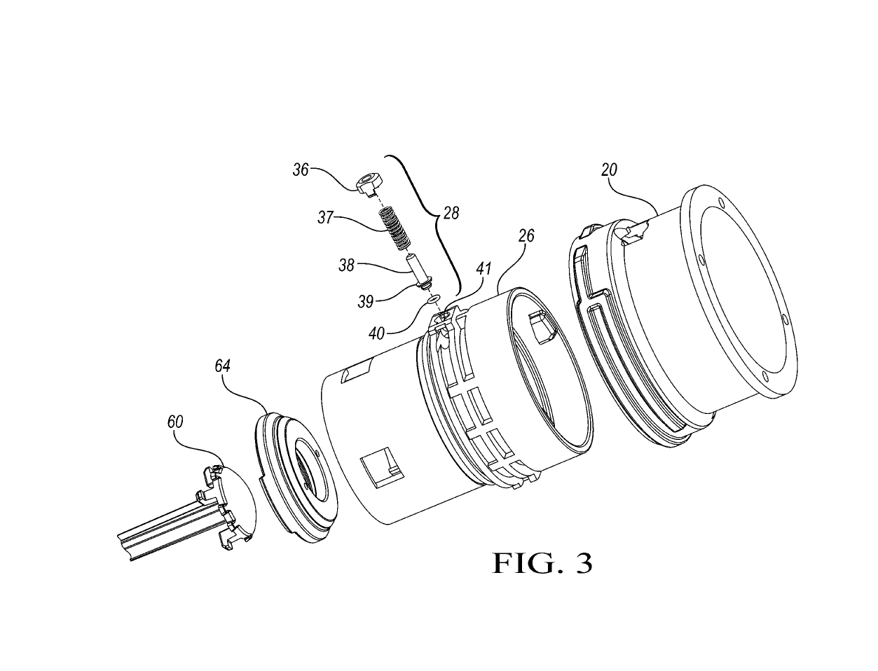

FIG. 3 is an enlarged view of the upper portion of FIG. 2. The pressure relief valve assembly 28 includes a cap 36 (which may be POM) having an aperture therethrough, a spring 37 (which may be stainless steel), a piston 38 (which may be POM), the piston 38 having a sealing surface 39 and an o-ring 40 (which may be EPDM). The pressure relief valve assembly 28 is configured to be received in a radial bore 41 through the annular wall of the inner retainer 26. In use, if the pressure inside the liner 14 ever exceeds a predetermined pressure (e.g. about 65-70 psi), the outward force on the piston 38 will overcome the spring 37. The piston 38 moves away from the sealing surface of the inner retainer 26 against which it seals, thus permitting fluid to exit the liner 14 until the pressure in the liner 14 drops below the threshold pressure. The released fluid flows between sealing surface 39 of the piston 38 and the o-ring 40, along the piston 38 (which has a diameter less than the radial bore 41) and through the aperture in the cap 36. This may prevent potential overpressure situations from getting high enough to cause damage to the keg 10. If the keg 10 is in an upright position and is being filled (or just increasing in temperature), the fluid that is released from the keg 10 through the pressure relief vale assembly 28 should be mostly CO2 because the pressure relief valve assembly 28 is at the top of the keg 10. After the pressure is reduced sufficiently, the spring 37 forces the piston 38 to seal against the o-ring 40 again.

The outer retainer 20 is securable to the inner retainer 26, such as by threading or a snap-fit connection. As shown, the pressure relief valve assembly 28 is receivable in a radial bore 41 through an annular wall of the inner retainer 26.

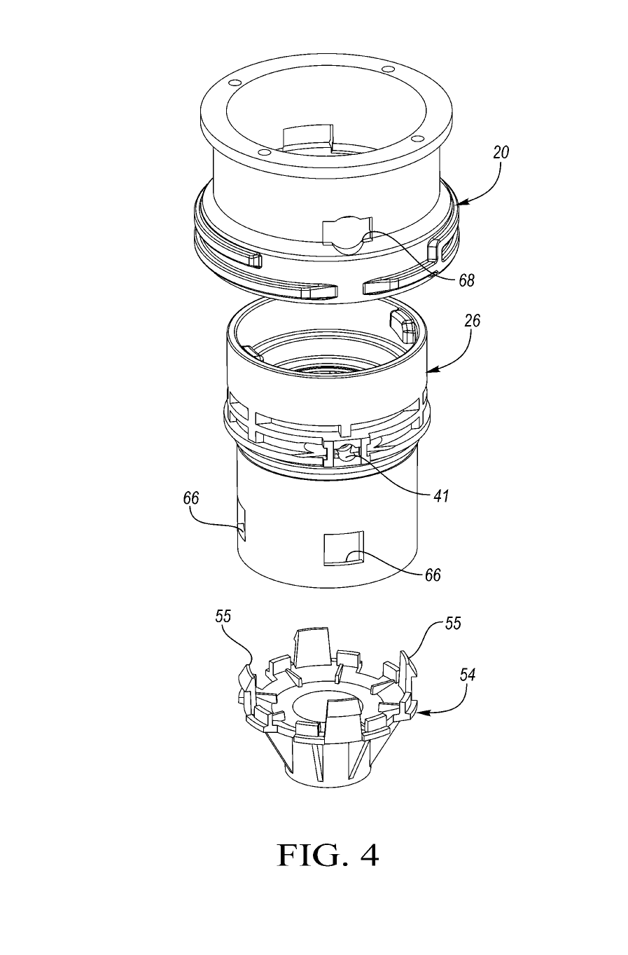

FIG. 4 is an exploded view of the retainer assembly including outer retainer 20, inner retainer 26 and retainer cap 54. The retainer cap 54 has a plurality of snap-fit fingers 55 that are complementary to openings 66 through the annular wall of the inner retainer 26 for securing the retainer cap 54 to the inner retainer 26. The outer retainer 20 includes an aperture 68 configured to align with the radial bore 41 in the inner retainer assembly 26 and the pressure relief valve assembly 28 (FIG. 3). The radial bore 41 and the aperture 68 align to provide a flow path from the body of the liner 14 to the exterior (atmosphere) of the keg 10.

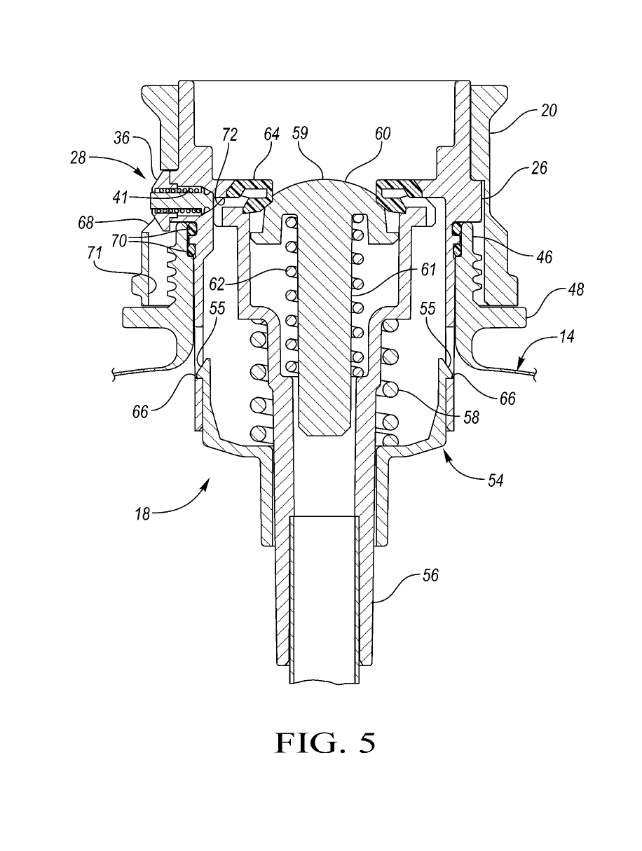

FIG. 5 is a section view through the assembled valve assembly 18 installed on the liner 14 (i.e. without the lid 16 or locking ring 22). The outer retainer 20 is connected to the inner retainer 26 and leaves an annular gap between them in a lower portion of the assembly. At least a portion of the neck 46 of the liner 14 is received within the annular gap and may be secured to the neck 46 by threads, snap-fit, etc. The o-ring 70 creates a seal between the inner retainer 26 and the neck 46 on an inside surface of the neck 46. This prevents damage to the o-ring 70 when the retainer assembly is attached to the neck 46. Another o-ring (not shown) can be placed in the annular recess above the o-ring 70 in addition to or instead of the o-ring 70. The radial bore 41 and the aperture 68 are both above the neck 46 of the liner 14. The flowpath through the radial bore 41 is just below where the piston 64 seals against an annular surface of the inner retainer 26. The pressure relief valve assembly 28 is shown in the radial bore 41 of the inner retainer 26 with the cap 36 received partially in the aperture 68 through the outer retainer 20. When the inner retainer 26 is slid into the outer retainer 20, the cap 36 slides through an axial groove 71 formed in the inner surface of the annular wall of the outer retainer 20, extending from the lower edge to the aperture 68.

As can be seen in FIG. 5, the force of the compressed spring 58 is contained entirely between the retainer cap 54 and the inner retainer 26. Thus, the retainer cap 54 and inner retainer 26 are made of a more dimensionally stable material that resists creep, such as POM, which is also suitable for direct contact with food (beer). This means that the force of the spring 58 does not bear on the connection between the outer retainer 20 and the neck 46 of the liner 14. Further, the outer retainer 20 can be made of a more durable material, such as glass-filled nylon, to provide a stronger, more durable connection to the locking ring 22 (but does not directly contact the beer). The spring 58 is directly between the retainer cap 54 and the valve body 56, biasing the valve body 56 upward within the retainer assembly against the piston 64. The piston 54 bears against an inner annular surface 72 formed on a portion of reduced inner diameter of the inner retainer 26 above the pressure relief bore 41 through the inner retainer 26. The inner spring 62 is captured between the valve body 56 and the port 60, biasing the port 60 upward against the piston 64. Thus, both of the springs 58, 62 are captured within the valve assembly 18 and the forces of the springs 58, 62 do not bear on the connection between the valve assembly 18 and the liner 14.

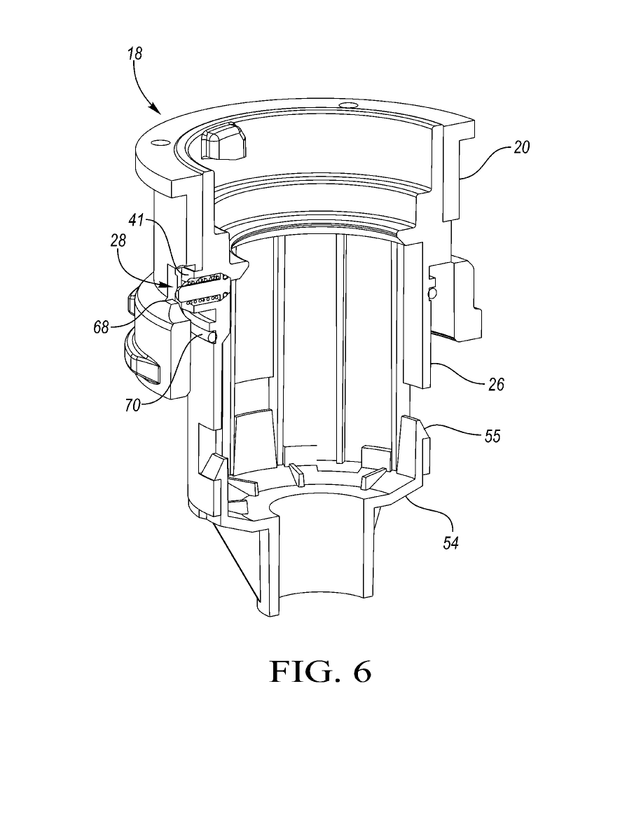

FIG. 6 is a perspective cutaway of the outer retainer 20, inner retainer 26 and retainer cap 54 assembled together with the pressure relief valve assembly 28 installed in the radial bore 41 of the inner retainer 26.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A beer keg assembly comprising:
a liner having a body portion and a neck portion; and
a valve assembly in the neck portion of the liner, the valve assembly including a retainer capturing an inner spring biasing a port and a piston toward one another.

2. The beer keg assembly of claim 1 further including a connection between the valve assembly and the neck portion of the liner such that the inner spring does not impart force on the connection between the valve assembly and the neck portion.

3. The beer keg assembly of claim 2 wherein the connection between the valve assembly and the neck portion is a threaded connection.

4. The beer keg assembly of claim 1 wherein the retainer includes an inner retainer portion having an inner annular surface formed on a portion of reduced diameter against which force from the inner spring bears via the port and the piston.

5. The beer keg assembly of claim 4 wherein the retainer includes a cap secured to a lower end of the inner retainer portion and wherein the force from the inner spring bears against the cap, such that the force of the inner spring is captured between the cap and the inner annular surface of the inner retainer portion.

6. The beer keg assembly of claim 1 further including an outer spring biasing a valve body bearing the inner spring, wherein the outer spring is captured within the retainer such that the outer spring does not exert a force on a connection between the valve assembly and the neck portion of the liner.

7. The beer keg assembly of claim 1 wherein the retainer further includes an outer retainer secured to an inner retainer portion and wherein the outer retainer is secured to an outer surface of the neck portion.

8. The beer keg assembly of claim 1 further including a pressure relief valve disposed in a fluid path leading through a wall of the retainer.

9. The beer keg assembly of claim 8 wherein the retainer includes an inner retainer portion having an inner annular surface formed on a portion of reduced diameter against which upward force from the inner spring bears via the port and the piston, wherein the fluid path of the pressure relief valve extends through the inner retainer portion below the inner annular surface.

10. A beer keg assembly comprising:
a liner having a body portion and a neck portion; and
a valve assembly in the neck portion of the liner, the valve assembly including a retainer having an annular wall sealing against the neck portion, a fluid passage extending through the annular wall, a pressure relief valve in the fluid passage.

11. The beer keg assembly of claim 10 wherein the pressure relief valve is secured within the annular wall of the retainer.

12. The beer keg assembly of claim 11 wherein the retainer includes an inner retainer portion including the annular wall, the retainer further including an outer retainer portion secured to the inner retainer portion and secured to the neck portion.

13. The beer keg assembly of claim 12 wherein the fluid passage extends through the inner retainer portion and the outer retainer portion.

14. The beer keg assembly of claim 13 wherein the inner retainer portion has an inner annular surface formed on a portion of reduced diameter against which upward force from an inner spring bears via a port and a piston, wherein the fluid path of the pressure relief valve extends through the inner retainer portion below the inner annular surface.

15. The beer keg assembly of claim 14 further including an outer container, the liner received in the outer container, a lid secured to the outer container and having an opening, a portion of the valve assembly extending through the opening in the lid, the beer keg assembly further including a locking ring secured to the outer retainer portion such that the lid is between the locking ring and the liner.

16. A beer keg assembly comprising:
a liner having a body portion and a neck portion; and
a valve assembly in the neck portion of the liner, the valve assembly including an inner retainer portion having an inner annular surface formed on a portion of reduced diameter, a cap secured to the inner retainer portion, at least one spring imparting force between the cap and the inner annular surface.

17. The beer keg assembly of claim 16 wherein the at least one spring includes an inner spring biasing a piston and a port against one another.

18. The beer keg assembly of claim 17 wherein the at least one spring further includes an outer spring, wherein the inner spring and the outer spring are both captured between the inner annular surface and the cap.

19. The beer keg assembly of claim 16 further including a pressure relief valve disposed in a fluid path leading through a wall of the inner retainer portion.
